(19) United States
(12) Patent Application Publication
(10) Pub. No.: US 2019/0256422 A1
(43) Pub. Date: Aug. 22, 2019

(54) Manufacturing of an artificial igneous rock material by a sintering process

(71) Applicant: Glassolite Group Ltd., Uxbridge (GB)

(72) Inventor: Finn Erik Solvang, Notteroy (NO)

(21) Appl. No.: 16/345,731

(22) PCT Filed: Oct. 30, 2017
(86) PCT No.: PCT/EP2017/077766

§ 371 Date: Apr. 29, 2019

Related U.S. Application Data
(60) Provisional application No. 62/481,710, filed on Apr. 5, 2017.
(60) Provisional application No. 62/414,817, filed on Oct. 31, 2016.

(51) Int. Cl. C04B 32/00; C04B 38/10

(52) U.S. Cl. CPC C04B 32/005; C04B 2111/40; C04B 38/10

(57) ABSTRACT

A method of making a porous silicate based material with similar properties as an extrusive or intrusive igneous silicate based rock without being naturally occurring. Quartz sand with a silica content (SiO₂) of more than 75% is mixed with Sodium oxide, Calcium oxide, and Aluminum oxide and heated up to a temperature of more than 960° C. and for the chemical reactions to take place and for the molten mixture to reach an elastic state where the viscosity allows the formed gasses to be dissolved into the melt. The sintering process may be at atmospheric pressure or at positive pressure. The material is then cooled to a solid. The process gives a porous igneous rock with micro cells based on CO₂ bubbles made at a temperature prior to the molten mixture reaching a plastic state. The solid material may be milled and used as a filter material. In one aspect, the solid is milled, mixed with a foaming agent, melted and cooled in order to form an even more porous second solid material.

### FIELD OF INVENTION

The present invention relates to the manufacturing and use of an artificial, inorganic, porous, igneous silicate based rock material, made from a process of sintering a mixture of quartz sand and minerals by an extrusive or intrusive process, and further a method of processing the igneous silicate based rock material into other commercial products.

### BACKGROUND

Due to increased demand for clean recycled glass cullet to be used in traditional glass production the amount of recycled glass available for the making of other high-quality foamed glass products is limited. In addition, the cost of sorting the collected glass and the amount of CO₂ created from transport of the recycled glass material are high.

Due to increased demand for pumice stones from open quarries to be used as media filter in water treatment or pre-treatment of salt water or brackish water before reverse osmosis, the negative environmental impact is huge, and at the same time the quality of the extracted pumice stone material is not as consistent and high as before and sometimes it needs to be refined before use.

In some instances, the use of materials made from recycled glass may cause risk of contaminating the ground water when used in infrastructure project below ground, or limit its use as infill in concrete due to its high alkali reactivity, or limit its use as a clean and inert media filter in fresh water treatment.

The present invention provides a pure and inert raw material with low alkali reactivity to be used as raw material when making infill in concrete, a material without any content of antimony, arsenic or other substances that causes any harm to the ground water if used as raw material for lightweight aggregate, a clean and stable material that can be used as media filter in water treatment and pre-treatment before reverse osmosis, and as growth media in hydroculture without any harm for plants, animals or humans.

This material can replace partially or in full the use of recycled glass in making of cellular glass products, the use of expanded clay as infill in concrete, and the use of pumice stones, perlite, quartz sand, glass sand and other material as media filter in fresh water treatment, pre-treatment before desalination, koi ponds, and it can be used as a growth media in hydroculture.

The porous structure with open microcells on the surface and also throughout the material, makes it very well suited to be crushed down and still keep its porosity and large surface area.

### SUMMARY OF THE INVENTION

The present invention relates to a method of making a porous silicate based rock material with similar properties as an igneous silicate based rock without being naturally occurring.

The igneous rock material can either be made by an extrusive sintering process at atmospheric pressure or by an intrusive sintering process under positive pressure.

This material consists of a mixture of quartz sand and different minerals heated up to a maximum temperature in the range from 960° C. to 1200° C., and atmospheric pressure or at a positive pressure between 0.01 bar and 3.0 bar, for the chemical reactions to take place and for the mixture to reach an elastic state and at a viscosity where the formed gasses are dissolved into the molten material without entering into a plastic state.

The positive pressure under an intrusive process can be achieved either by calculating the height of the furnace to use the weight of the mineral mixture to build up pressure, or to place the furnace inside a pressure chamber with the desired pressure.

The desired cell size of the igneous rock material will depend on the size of the particles of the foaming agent, the viscosity of the molten mixture, the positive pressure on the molten mixture when the mixture has reached its maximum temperature, and the process time at maximum temperature.

The main ingredient is quartz sand with a silica content of more than 70%. Then Sodium oxide is added to lower the melting point of the quartz, and Calcium oxide as stabilizer, for not making the igneous rock water soluble. If the quartz sand does not contain any aluminum oxide, a smaller amount can be added to the mixture to increase strength after the ceramic particles have been fused together.

The maximum temperature given by the viscosity of the molten material during its elastic state, and the positive pressure used, should be optimized so that the formed gas bubbles do not raise in the molten mixture but is trapped inside, forming an almost uniform cell structure before entering out of the bottom of the furnace to be cooled down to ambient temperature for further processing.

By trapping the CO₂ gas created during the elastic state into the molten rock material, the amount of CO₂ released to the atmosphere is significantly lower than in traditional glass production where almost all CO₂ is removed during the refining of the glass at temperatures locally up to 1675° C.

Chemical reaction when heated (based on quartz sand with 99.9% SiO₂):

Na₂CO₃+CaCO₃+6SiO₂=Na₂O.CaO.6SiO₂+2CO₂

When using quartz sand with a lower SiO₂ content, the chemical composition can be as follows:

An example of chemical composition after reaction:

| Ingredient | Wt % |
|---|---|
| SiO₂ | 60-90 |
| Al₂O₃ | 2-10 |
| CaO₂ | 2-10 |
| Na₂O | 2-10 |
| K₂O | 0-3 |
| FeO₃ | 0-2 |
| MgO | 0-1 |
| TiO₂ | 0-1 |

The process gives a porous igneous rock with micro cells mainly based on CO₂ bubbles made at a temperature where the given viscosity of the molten material doesn't allow the formed gas bubbles (seeds and blisters) to escape before it has been cooled down to a temperature where it reaches a solid state.

By use of a furnace, the mixture is heated to a temperature between 960° C. and 1200° C. to sinter the minerals without reaching a plastic state, to create bubbles from the chemical reaction that are taking place during its elastic state and to allow the bubbles to dissolve into the molten material, but not raise to the surface and form blisters. Changes in temperature and pressure will both influence the production time and also the amount of gasses dissolving into the molten material. The higher the viscosity, and higher the pressure, the higher the proportion of the released CO₂ gasses becomes dissolved in the molten material over a fixed time. Different fraction size of the quartz sand and minerals will change the reaction time, and the fraction size should preferably not exceed 4 mm.

According to one aspect, the making of the product takes place through an extrusive process in a horizontal melting furnace under atmospheric pressure, or according to another aspect through an intrusive process by the use of a vertical furnace, or by putting the furnace inside a pressure chamber with a positive pressure in the range of 0.01-3 bar pressure above atmospheric pressure. The positive pressure in combination with the given viscosity of the molten material after the mixture has reached its elastic state will create a more uniform cell size distribution than in a horizontal furnace with a pressure below 0.01 bar pressure. Changes in pressure will change the size of the gas bubbles. Increased pressure will make the cell structure more homogenous and the cells smaller, less pressure will allow the bubbles to grow and pair up with other bubbles to form blisters over time. This effect will increase with increased temperature. The process should be optimized so as to minimize the pairing of bubbles and to create as uniform cell structure as possible, this to increase the quality of the material before further processing.

According to another aspect, the movement of the vertical oriented downward melting process should be faster than the rising of the bubbles created in the molten mixture. This to allow all bubbles created to stay inside the molten mixture and to create an igneous rock with as many cells as possible, and as low density as possible, when extruded out of the bottom of the furnace and before cooling.

According to another aspect and to be able to create a filtration media with particle size from 0.3 mm to 4.0 mm with low density and large surface area, the positive pressure when making a porous artificial igneous rock through an intrusive process is preferably adjusted so that the cell size decreases, and the mineral filter keeps its porosity and large surface even after crushing down to the desired size.

According to another aspect, an aluminum oxide (Al₂O₃) content of more than 2%, but no more than 10% in the quarts sand, will increase the strength of the cell walls and increase the melting point of the artificial igneous rock. If the quarts sand does not contain alumina, this can be added as part of the melting process, based on the specific end use of the artificial igneous rock material.

### BRIEF DESCRIPTIONS OF THE DRAWINGS

The invention will now be described with reference to the attached figures, wherein:

FIG. 1 is a photograph of aggregates of an artificial porous silicate based igneous rock according to the invention made by an extrusive heating and cooling process.

FIG. 2 shows material of the invention crushed into 0-2 mm sand.

FIG. 3 shows crushed artificial igneous rock 1.6-2.5 mm prepared for use as filtration media for fresh water treatment.

FIG. 4 shows the porous surface structure of crushed aggregate made by an extrusive process with cells in the range from 0.1-10 mm.

FIG. 5 shows milled artificial igneous rock with a fraction size of 0-100 micron.

FIG. 6 shows mineral foam made at 850° C. from artificial igneous rock powder 0-100 micron mixed with 4% AlN and 1% MnO₂ as foaming agent. Block density 200 kg/l.

FIG. 7 shows mineral foam (cellular glass) material made from artificial igneous rock powder, with AlN and MnO₂ as foaming agents, further showing the internal cell structure of the cellular glass material.

FIG. 8 shows a vertical oven used in one embodiment of a method of the invention

FIG. 9 shows a casted article with milled artificial rock material 0-100 micron heated with a gasifier to form a cellular low density mineral foam product. Foaming agent AlN forming mineral foam/cellular glass at 850° C.

FIG. 10 show a set up for a high pressure dual filter for fresh water treatment, with 0.8-2.5 mm artificial rock foamed with SiC as gasifier to form a low density filter media for the top layer, and 0.3-0.8 mm crushed igneous rock as the lower layer.

FIG. 11 shows 0.3-0.6 mm crushed artificial igneous rock as filtration media for fresh water treatment.

FIG. 12 shows 0.8-1.8 mm foamed and crushed igneous rock as filtration media for fresh water treatment and as pre-treatment for reverse osmosis.

FIG. 13 shows 1.6-2.5 mm foamed and crushed igneous rock as filtration media for fresh water treatment and as pre-treatment for reverse osmosis.

FIG. 14 shows 1.6-4.0 mm foamed and crushed igneous rock as filtration media for fresh water treatment.

### DETAILED DESCRIPTION

According to one aspect of the invention, a method for production of an artificial igneous rock, method is described in detail as follows:

65-84% by weight of Quartz sand with high SiO₂ content is mixed with 8-20% by weight of Sodium oxide (Na₂Co₃), 8-15% by weight of Calcium oxide (CaCo₃), and 2-10% by weight of Aluminum oxide (Al₂O₃) and heated up to a temperature in the range from 960° C. to 1200° C. The mixture is heated over the course of from 30 to 180 minutes, preferably over the course of 60 to 120 minutes, most preferably over the course of approximately 90 minutes. For lowering of the melting temperature, a portion of ready-made synthetic igneous rock milled down to fraction size below 1 mm may be added (10-40% by weight).

Example of production of igneous rock by an extrusive process under atmospheric pressure:

75% Quarts sand (including 7.5% Aluminum oxide)+15% Sodium oxide+10% Calcium oxide Batch of 2 kg, density 1.6 kg/l.

Height of mixture: 100 mm

Positive pressure: 0.016 bar at the bottom of mixture Heating from 20° C. to 1050° C. over 60 minutes

Hold at Tmax (maximum temperature) 30-90 min (depended upon the grain size), in this example 60 min with a grain size <0.8 mm

Then temperature is reduced to ambient temperature in a controlled temperature zone to reduce stress in the artificial rock.

The temperature is lowered before the molten mixture has reached a plastic state and just before any significant amount (preferably zero) gas bubbles start to pair up and burst through the surface of the melt. This can be observed as large craters on top of the surface of the melt.

The process time will depend on the amount of Sodium oxide in the blend and the maximum temperature used. A higher temperature and/or higher content of Sodium oxide gives a shorter process time.

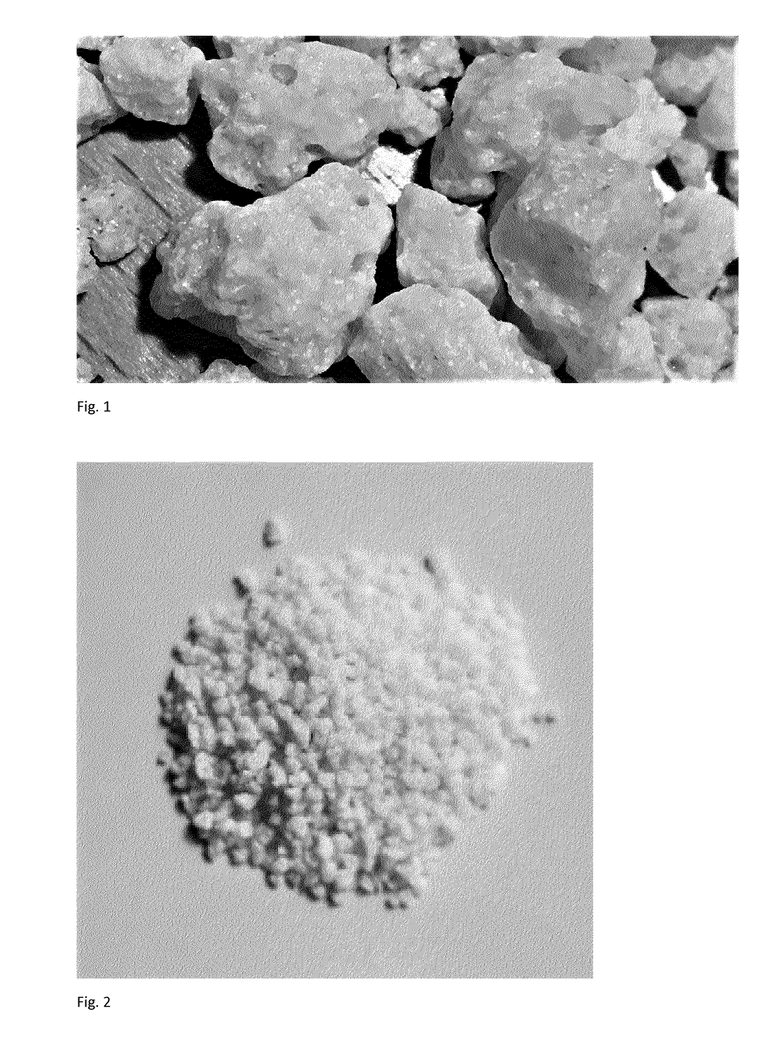

In FIG. 1, some samples produced by the process are shown. The method used in this example:

The blend consists of 75% Silicon dioxide, 15% Sodium oxide and 10% Calcium oxide. Heated up in a furnace to a maximum temperature of 1050° C. and kept at maximum for 60 minutes before cooled down to room temperature, for further processing.

According to another aspect of the invention, a method for crushing the artificial igneous rock into sand for further use as filtration media for water treatment is possible.

An Example of Usage:

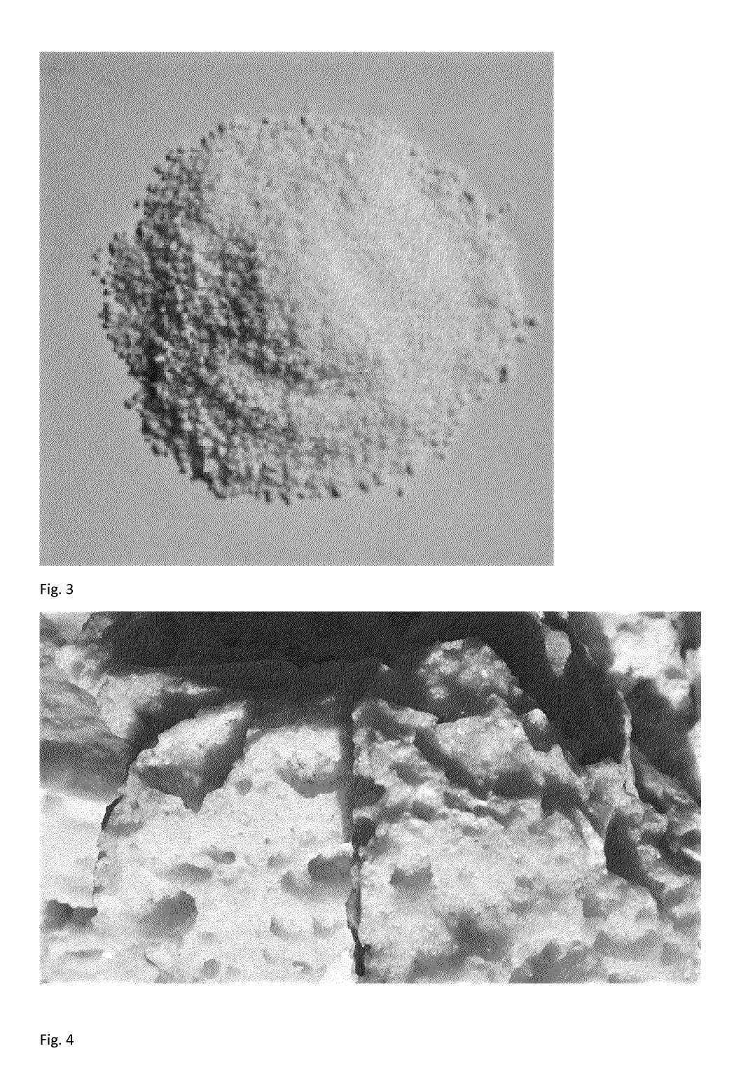

As shown in FIGS. 3 and 4, the artificial rock is crushed into fractions of 0-4 mm size, then again sieved into a different fraction sizes in the range between 0.3-4 mm. Because of its porous and large surface with open micro cells in the range of 0.1-0.4 mm the crushed rock material can be used as a filtration media for fresh water treatment, as pre-treatment of salt water and brackish water before reverse osmosis and as filtration for swimming pools.

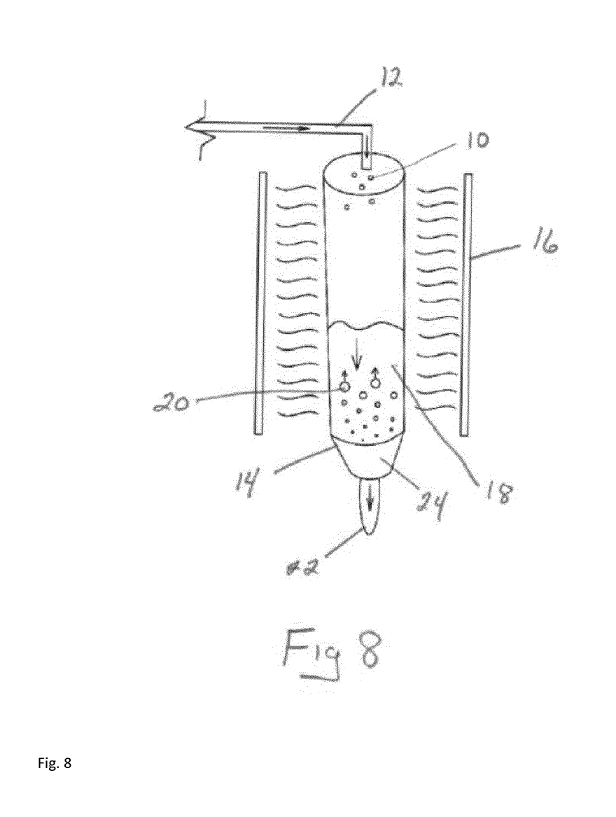

If filtration media with small particle size and large surface area is needed, the igneous rock can be made by an intrusive process under positive pressure (preferably from 0.01-3 bar) to create a smaller cell structure, preferable with a cell size down to 0.01 mm. According to one aspect, this can be achieved by performing the process under positive pressure in a pressure chamber. According to another aspect, illustrated in FIG. 8, this can be performed in a vertical oven arrangement. As shown in FIG. 8, a mixture 10 of the ingredients is fed by a supply tube 12 from the top of a vertical oven 14 and onto the top of the molten mixture 18 inside the furnace. The oven is heated by a heat source 16. The mixture is heated to a temperature above 960° C., melting the mixture. The weight of the column 18 of molten mixture creates a positive pressure, preferably of from 0.01-3 bar. As shown, bubble 20 formed in the molten mixture attempts to rise to the surface. The molten material 22 is allowed to exit a nozzle 24 with a given size. The size of the opening of nozzle 24, as well as the maximum temperature to allow the downward rate of flow of the molten material to be equal to or faster than the rate of upward rising of the bubbles, in order to contain as much gas in the molten mixture as possible. The molten material exiting the nozzle is allowed to a solid, porous material.

According to another aspect of the invention, a method for lowering the density of the filtration media is provided. By milling the igneous rock down to a fraction size below 700 micron, then adding 0.5-5% of a foaming agent such as SiC, MnO2, AlN or a combination of them, then heating up the mixture to a temperature from 820° C. to 1000° C., to create a foamed product with micro cells, then cool down to ambient temperature, then crush the foamed artificial igneous rock into the desired fraction sizes as shown in FIGS. 12, 13 and 14.

Fraction sizes used for filtration media can be in the range:

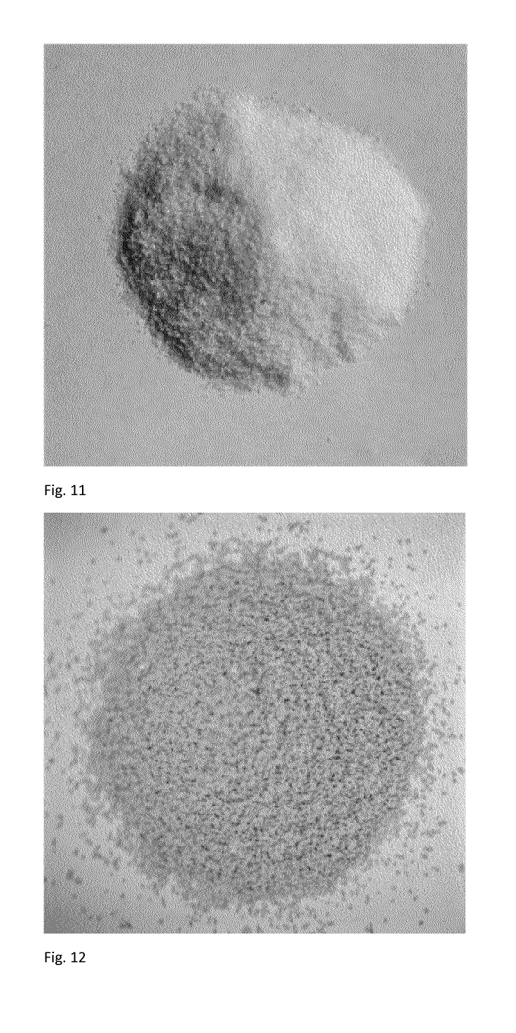

0.3-0.6 mm, FIG. 11

0.8-1.6 mm, FIG. 12

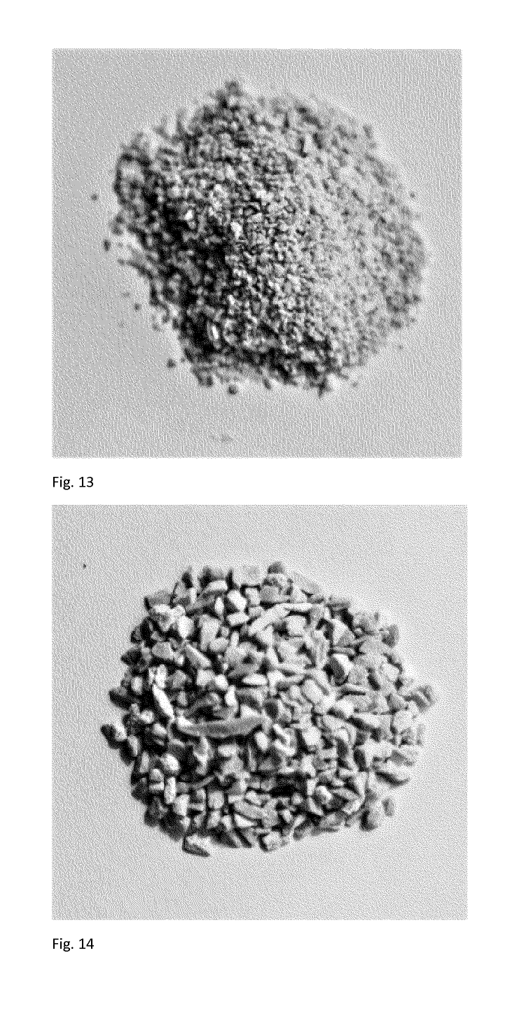

1.8-2.5 mm, FIG. 13

2.5-4.0 mm, FIG. 14

Other ranges can be used dependent upon the end user filtration equipment and need.

Absolute particle density for the filtration media can range from 1.05 kg/l to 1.8 kg/l.

According to another aspect of the invention, a method of replacing recycled glass as the main raw material for production of cellular glass by methods known in the art is shown in FIGS. 5,6 and 7. According to this aspect of the invention, the artificial igneous rock aggregates is milled down to a powder, normally from 0-800 micron. In some cases larger fractions can be used. The powder is then mixed with foaming agents such as SiC+MnO₂, or AlN+MnO₂, or Na₂SiO₃, or other foaming agents that reacts with the molten igneous rock to create gas bubbles at temperatures from 750° C. to 1000° C. The molten and foamed igneous rock material is then processed into different foam glass products.

An Example of Usage:

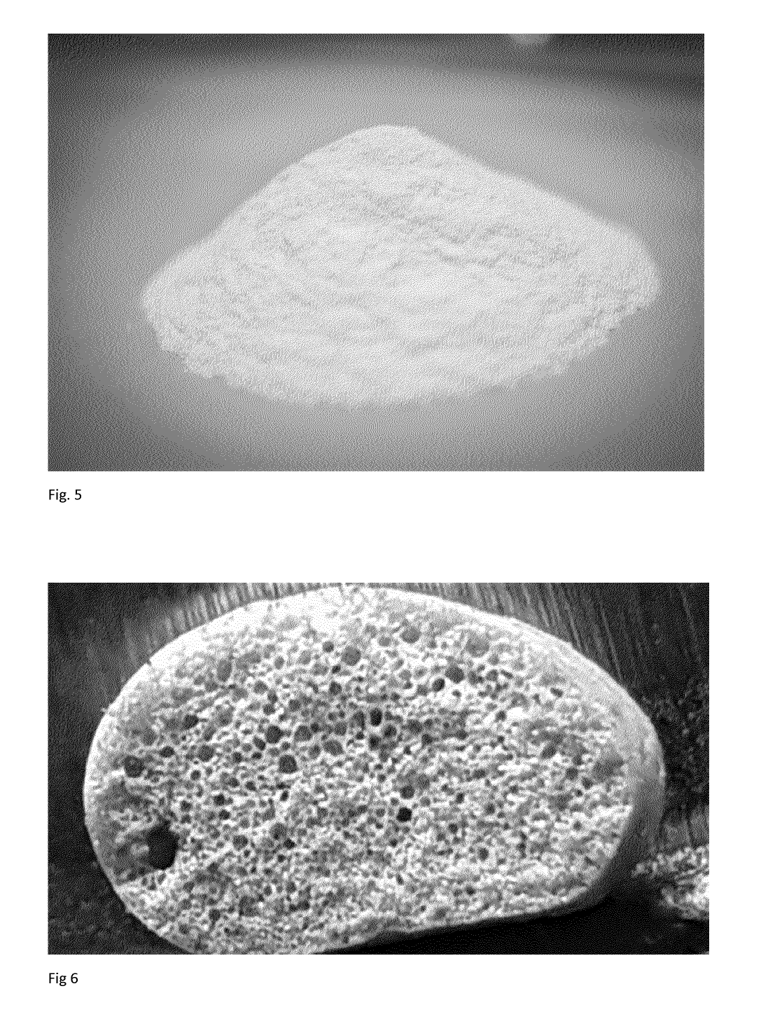

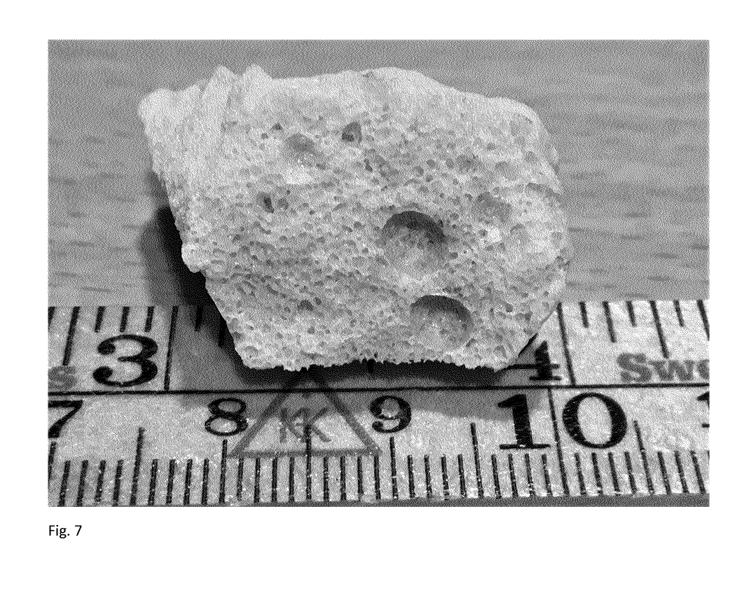

A powder as shown in FIG. 5, is prepare by milling the rock material of the invention. To the powder is added 4% by weight AlN and 1% by weight MnO₂ (with 95% by weight of artificial igneous rock powder with a fraction size of 0-600 micron). The mixture is melted by being heated to a temperature of 900° C. The melt is then maintained at maximum temperature for 30 minutes before cooled down to room temperature, resulting in a porous foam glass material, a sample is shown in FIG. 6. The foamed igneous rock can be crushed into aggregates with a sealed cell structure of 0.1-3 mm as shown in FIG. 7.

Some characteristics of the cellular rock product:

Block density: 300-800 g/l

Thermal heat capacity: 0.050-0.090 W/mK

Compression strength: >1.5 MPa

Average cell size: 1 mm

Another Example of Usage:

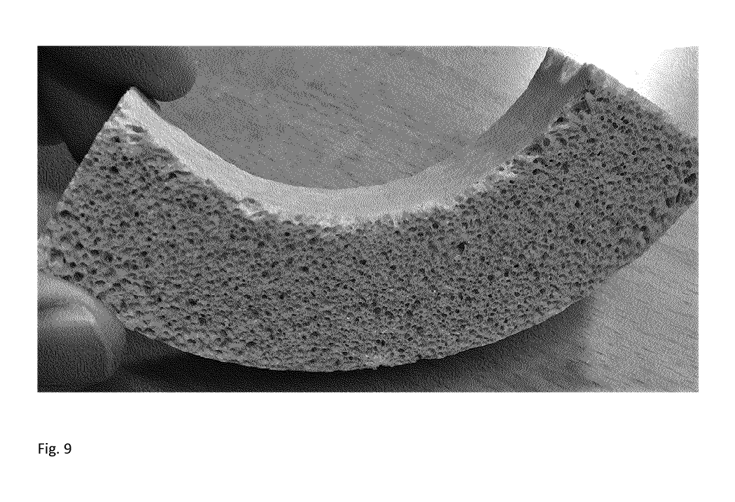

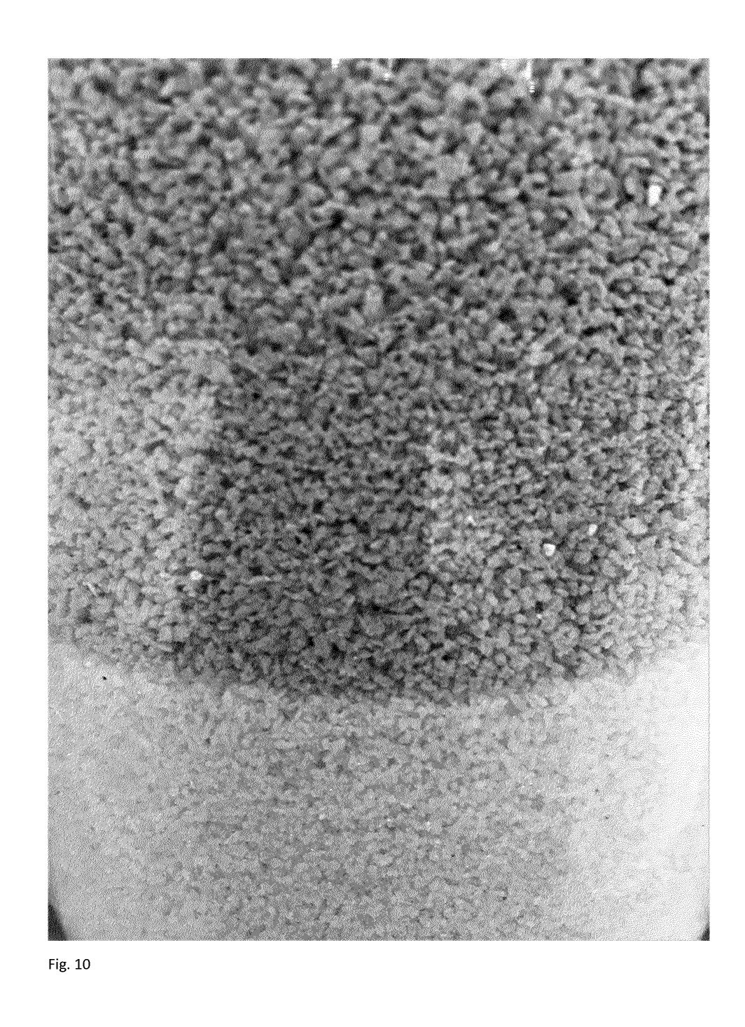

An artificial igneous rock powder 0-100 micron as shown in FIG. 5 is prepared by milling the rock material of the invention. To the powder is added 2% by weight SIC and 1% by weight MnO2. The mixture is then added to a mold. The mold is then placed in an oven at 900° C. for one hour, then cooled down to room temperature, resulting in a casted mineral form article, a sample shown in FIG. 9.

Some characteristics of the casted mineral foam product:

Block density: 400-600 g/l.

Compression strength: >7.5 MPa

1-11. (canceled)

12. A method for making an artificial, silicate-based igneous rock material, comprising the steps of:
a. Providing a mixture consisting of 65-85% by weight of Quartz sand with a SiO₂ content of above 75%, 8-20% by weight of Sodium oxide (Na₂Co₃), 8-15% by weight of Calcium oxide (CaCo₃), 2-10% by weight of Aluminum Oxide (Al₂O₃).
b. Heating the mixture to a temperature in the range from 960° C. to 1200° C., whereupon the molten mixture enters its elastic state,
c. Heating the mixture at atmospheric pressure or under a pressure from 0-3 bar above atmospheric pressure,
d. Cooling the sintered mixture until the mixture forms a solid

13. The method according to claim 1, wherein the molten mixture is cooled prior to the mixture entering into a plastic stage at an average temperature of 1150° C., and prior to any significant amount of gaseous bubbles bursting though the surface of the molten mixture.

14. The method according to claim 1, wherein the mixture is heated to a maximum temperature (Tmax) over the course of from 30-120 minutes, preferably from 50-90 minutes, and most preferably over the course of approximately 60 minutes.

15. The method according to claim 1, wherein a vertical orientated furnace is used to create a positive pressure on the molten mixture due to the weight of the mixture.

16. The method according to claim 1, wherein the mixture is heated in a vertically oriented furnace (14) to a molten material (22), said molten material exiting a nozzle (24), wherein the furnace is arranged such that the molten material flows downward at a higher rate than any upward movement of bubbles (20) created during the heating process.

17. The method according to claim 1, wherein the molten material is cooled to ambient temperature within 300 minutes or less.

18. The method according to claim 1, wherein the molten material is held at Tmax from 15-120 minutes.

19. The method according to claim 1, wherein the heating and cooling of the mixture are performed at atmospheric pressure.

20. The method according to claim 1, wherein the heating of the mixture is performed at a positive pressure of from 0.01-3 bar.

21. The method according to claim 1, wherein the mixture further consists of from 10-40% of rock aggregate made according to one of the proceeding claims, milled to a grain size of 1 mm or less.

22. The method according to claim 1, further comprising the steps of milling the solid into powder with fraction size below 800 micron, adding a foaming agent, heating the resultant second mixture of milled solid and foaming agent until said second mixture melts and reacts to form a foamed mineral product, and cooling said second mixture to a more porous and less dense second solid.

23. A rock aggregate material made according to one of the preceding claims.
